(19) United States
(12) Patent Application Publication
(10) Pub. No.: US 2026/0371103 A1
(43) Pub. Date: Nov. 19, 2026

(54) USING FEDERATED LEARNING TO GENERATE THREE DIMENSIONAL RADIO MAPS

(71) Applicant: Telefonaktiebolaget LM Ericsson (publ), Stockholm (SE)

(72) Inventors: Mohammad MOZAFFARI, Fremont, CA (US); Mingzhe CHEN, Plainsboro, NJ (US); Mehrnaz AFSHANG, Fremont, CA (US); Hamza KHAN, Helsinki (FI)

(73) Assignee: Telefonaktiebolaget LM Ericsson (publ), Stockholm (SE)

(21) Appl. No.: 19/135,400

(22) PCT Filed: Dec. 9, 2022
(86) PCT No.: PCT/IB2022/062006

§ 371 Date: Jun. 4, 2025

(51) Int. Cl. H04W 24/02; H04W 64/00

(52) U.S. Cl. CPC H04W 24/02; H04W 64/00

(57) ABSTRACT

A method for use in generating a three-dimensional, 3D, radio map. The method is performed by a first unmanned aerial vehicle, UAV. The method includes generating a locally trained model configured to map input data to a predicted signal quality value, wherein the input data comprises location information specifying a location in a 3D space, and the predicted signal quality value is one of: predicted average Reference Signal Received Power, RSRP, value; Signal-to-Noise Ratio, SNR; Signal-to-Interference-plus-Noise Ratio, SINR; Reference Signal Received Quality, RSRQ; Block Error Rate, BLER; or throughput. The method also includes transmitting model parameters for the locally trained model to a network node, wherein the network node is a base station, server, or a second UAV.

### TECHNICAL FIELD

Disclosed are embodiments related to radio mapping.

### BACKGROUND

A radio map is a set of data that provides information about network coverage. A radio map is a useful tool for network planning and/or network operation.

### Internet-of-Things (IoT) and 5G

The Evolved Packet System (EPS) was specified in 3GPP Release 8. EPS is based on the Long-Term Evolution (LTE) radio network and the Evolved Packet Core (EPC). It was originally intended to provide voice and mobile broadband (MBB) services but has continuously evolved to broaden its functionality. Since Release 13, Narrowband Internet of Things (NB-IoT) and LTE for Machine type communication (LTE-M) are part of the LTE specifications and provide connectivity to massive machine type communications (mMTC) services.

In 3GPP Release 15, the first release of the 5G system was developed. 5G is a radio access technology intended to serve many use cases such as: enhanced mobile broadband (eMBB), ultra-reliable and low latency communication (URLLC), and mMTC. 5G includes the New Radio (NR) access stratum interface and the 5G Core Network (5GC). The NR physical and higher layers reuse parts of the LTE specification, and to that add needed components when motivated by the new use cases.

5G introduces features which can create significant complexity and challenges to network design and optimization, some of the features include: (1) diverse deployment options, (2) wide range of frequency bands, (3) advanced antenna technologies, and (4) highly flexible air interface. These four features are described below.

(1) Diverse deployment options: Initial Non-Standalone Architecture (NSA) for 5G NR deployment relies on 4G LTE for control signaling and Core support. Standalone Architecture (SA) for 5G NR deployment uses the new 5GC. 4G LTE and 5G NR will coexist for many years to come, requiring joint network design and optimization of 4G and 5G while taking into account any legacy 2G and 3G networks as appropriate. The deployment may involve multiple layers consisting of macro cells and diverse types of small cells. In addition, the separation of CU (Centralized Unit) and DU (Distributed Unit) can be used to enable virtualized RAN or Cloud RAN deployment, introducing additional deployment complications.

(2) Wide range of frequency bands: 5G NR features spectrum flexibility and supports operation in the spectrum ranging from low band, mid-band to high band millimeter wave. Network design and optimization across the wide range of frequency bands to achieve the best performance of coverage, capacity, data rate, and latency are complex.

(3) Advanced antenna technologies: NR features a beam centric design to leverage advanced antenna technologies. The planning of beam patterns will impact network coverage, user throughput, mobility performance, among others. The number of supported broadcast beams may be up to 8 in sub-6 GHz and up to 64 in millimeter wave, resulting in escalated complexity in network design and optimization.

(4) Highly flexible air interface: 5G NR, by design, is inherently flexible and provides a great level of configurability to support the diverse 5G use cases and their demanding network performance requirements. The flexibility, however, also makes finding the right optimized configuration parameters tailored to a given deployment scenario a challenging task.

### UAV Communications

Unmanned aerial vehicles (UAVs) (a.k.a., “drones”) play a key role in a wide range of use cases and scenarios which can go beyond 5G and 6G wireless systems. Due to the unique aspects of UAVs, such as mobility, flexibility, and their autonomous operation, they can be extensively used in various applications while offering new business opportunities. The examples of UAV applications include: package delivery, media production, real-time surveillance, and remote constructions. Moreover, UAVs are considered as key players in smart city and IoT ecosystems.

Mobile networks traditionally serve devices on the ground, but interest and business case for using mobile networks, including both existing LTE networks and emerging 5G networks, to provide connectivity to low altitude UAVs have been growing fast. To operate properly, UAVs need to be effectively supported via cellular networks (a.k.a. cellular-connected UAVs) to ensure seamless connectivity and low-latency communications. In this regard, the efficient support of UAVs, particularly in the next generation wireless networks, faces new challenges due to their relatively high altitude, mobility, energy and flight time limitations, massive deployment, and flight safety requirements. In particular, there is a need for efficient handover (HO) mechanisms for UAV mobility management to provide reliable communications between base stations (BSs) and UAVs.

More specifically, compared with terrestrial UEs, efficient connectivity support for flying UAVs requires coping with several challenges, including: (1) high mobility, (2) down-titled BS's antennas, and (3) strong interference. These three challenges are further described below.

(1) High mobility: UAVs can move with high speed, typically along a flexible path in a three-dimensional (3D) space. Such mobility can result in a rapid fluctuation of the received signal power and link quality. In particular, UAVs can fly at different altitudes, which significantly impacts their propagation channel when communicating with ground BSs.

(2) Down-tilted BS's antenna: Terrestrial BSs are designed for serving UEs that are close to the ground. Therefore, the main lobes of the BS's antennas face towards ground and UAVs flying at relatively high altitudes are typically served by one or multiple side lobes with smaller beamwidth and antenna gain. In addition, in the BS's antenna pattern there exists several nulls that prevent the BS from providing continuous coverage in the sky (i.e., having coverage holes in the sky). Due to such BS's antenna pattern and special locations of UAVs with respect to BSs, the cell association pattern becomes fragmented in a multi-BS network.

(3) Strong interference: Given the line-of-sight (LoS) condition in BS-to-UAV communications, UAVs can experience severe downlink interference from neighboring cells. Similarly, in uplink communications, the dominant LoS channel between UAVs and BSs may result in strong interference.

The combination of mobility, altitude variations, interference, and antenna patterns result in complex 3D propagation characteristics in the sky.

3GPP initiated a study on the cellular-connected UAV in Release-15 to evaluate the capability of the LTE network in supporting UAV-UEs. In addition, the 3GPP Release-16 study item on remote UAV identification explored the potential requirements and use cases for remote identification. Meanwhile, the 3GPP Release 17 studied 5G enhancement for UAVs. In this work, new key performance indicators (KPIs) and communication requirements of UAVs with a 3GPP subscription are identified, which include KPIs for communication service, and for command and control traffic.

The performance of cellular-connected UAV networks can be further enhanced by leveraging tools from Machine Learning (a.k.a., Artificial intelligence (AI)). Network intelligence which is envisioned to be a key feature of 6G can play an essential role is UAV connectivity.

### Machine Learning

Machine learning (ML) is a technology that enables systems to improve their performance by learning from their environment and/or their past experience. For example, a ML model is trained using training data. In machine learning, training is the process that teaches the machining learning model to achieve a specific goal, such as for speech recognition. In other words, training enables the machine learning model to discover potentially relationships between the input data and output data of this machining learning framework. There exists, in general, four key classes of learning approaches: 1) supervised learning, 2) unsupervised learning, 3) semi-supervised learning, and 4) reinforcement learning.

ML is expected to play several roles in the next-generation of wireless networks. For example, ML can be used to exploit big data analytics to enhance situational awareness and overall network operation. In this regard, ML will provide the wireless network with the ability to parse through massive amounts of data, generated from various devices to create a comprehensive operational map of the massive number of devices within the network.

To design, deploy, and operate complex wireless networks (e.g., 5G and beyond), there is a need to increase efficiency, optimize performance, and automate network management, for which ML is essential. Specifically, ML can be leveraged to design and optimize UAV communication systems.

### ML in 3GPP Standardization

5G brings more stringent requirements for Key Performance Indicators (KPIs) like latency, reliability, user experience, and others; jointly optimizing those KPIs is becoming more challenging due to the increased complexity of foreseen deployments. Operators and vendors are now turning their attention to ML (a.k.a., AI/ML) to address this challenge.

3GPP has been studying ML-enabled radio access networks (RANs) in Release 17, including the principles, functional framework, use cases, and solutions. In Release 18, 3GPP will study AI/ML for NR air interface to enhance performance or reduce complexity/overhead. The study will establish a common AI/ML framework, identify areas where AI/ML can improve air interface functions, investigate how to describe and characterize AI/ML models, evaluate AI/ML techniques to understand their gains and complexity, and assess standardization impact. To achieve these objectives, 3GPP will focus on a set of selective use cases, including channel state information (CSI) feedback, beam management, and positioning. The study is expected to pave the way for other use cases leveraging AI/ML techniques in the air interface. The approved Release 18 study item on ML/AI is provided in 3GPP Technical Document No. RP-213599 (i.e., reference [1]).

6G standardization is expected to start in 3GPP around 2025. It is anticipated that the innovative works conducted in 5G Advanced, such as embracing ML technologies, will trigger a paradigm shift, lay a strong foundation for 6G design, and create a profound impact on future wireless networks.

### Federated Learning

Federated learning is a machine learning setting where multiple entities (a.k.a., “clients”) collaborate in solving a ML problem under the coordination of a central server or service provider. Each client's raw data is stored locally and not exchanged or transferred; instead, focused updates intended for immediate aggregation are used to achieve the learning objective.

That is, federated learning (FL) is a way to train a ML model using multiple clients that each have their own local dataset without having each client share its local dataset with the other clients. This approach stands in contrast to traditional centralized machine learning techniques where all the local datasets are uploaded to one server. With FL, a robust ML model can be created without the high cost of sharing the local datasets among all the clients.

The topic of FL for radio mapping has been studied in the literature, including: Khamidehi, et. al., “Federated learning for cellular-connected UAVs: Radio mapping and path planning.” In IEEE Global Communications Conference, 2020 (available at arxiv(dot)org (slash)pdf(slash)2008(dot)10054(dot)pdf) (see reference [2]); Zhang, S., et al. “Radio Map Based Path Planning for Cellular-Connected UAV,” in IEEE Global Communications Conference (GLOBECOM), 2019 (reference [3]); and Zhang, et. al., “Radio map-based 3D path planning for cellular-connected UAV.” IEEE Transactions on Wireless Communications 20.3 (2020): 1975-1989 (reference [4]).

These studies are mainly limited to specific scenarios and simplified models. For example, reference [2] uses federated learning to compute a global SINR outage model and using this model it performs the path planning, which is scenario limited. Although the prior art uses FL to perform radio mapping, it includes very few variables in the FL client dataset i.e., 2D location and indicator function of outage probability. Also, the FL approach in the previous work uses the dataset of all the UAVs to perform global parameter update. In addition, the FL approach in the previous work is implemented over a network that consists of one gNB and multiple UAVs. Therefore, the previous work uses a vanilla FL for radio mapping.

The existing studies mainly focus on a single-cell scenario (one base station). In practical scenarios, multiple base stations are deployed to provide a wide coverage. The existing studies only consider received signal power (RSRP/RSRQ) for performing radio mapping based on outage probability.

The work in reference [4] aims at exploiting a 3D radio map for UAV path planning but does not propose efficient solutions for generating scalable 3D radio maps. Specifically, in this work the channel gain (which is used for constructing an SINR map) for each base station is obtained offline by deploying dedicated UAVs for channel sensing and measurements. This approach has few potential limitations: 1) it only relies on a set of measurements with discrete samples, 2) it is not generalizable and adaptable to change of scenario/environment, and 3) it may not be feasible in terms of cost and complexity if it requires significant measurements. In fact, there is a need for solutions to generate 3D radio maps that are efficient in terms of cost, complexity, storage capacity, and power consumption while being scalable, generalizable, and adaptable to changes.

### SUMMARY

Certain challenges presently exist. For instance, cellular networks have been mainly optimized for serving terrestrial UEs, but, considering the ever-growing use of non-terrestrial UEs (e.g., UAVs equipped with a UE), cellular networks also need to meet communication requirements of non-terrestrial UEs (a.k.a., “UAV-UEs” or “flying UEs”). To this end, one needs to identify effective solutions for challenges associated with cellular-connected UAV systems. However, current cellular networks have been primarily designed for supporting terrestrial devices whose characteristics are significantly different from UAV-UEs. Naturally, challenges such as interference management, mobility management, and energy and spectrum efficiency will be further exacerbated by the use of UAV-UEs due to their relatively high altitude, stringent on-board energy limitations, dynamic roles, massive deployment, and their nearly unconstrained mobility. To efficiently support UAV-UEs, there is a need for new or enhanced solutions for network design, deployment and operation. To this end, one important step is to collect essential data, extract useful information, and create a generic model which can be utilized for design optimization.

In this regard, the main limitations are: 1) the amount of available data is limited, 2) the data or information is limited to a specific scenario or use case which may not be generalizable, 3) sufficient data collection may not be feasible or can be expensive, and 4) massive data processing/collection may result in a significant complexity and energy consumption while requiring a huge storage capability. These limitations result in a sub-optimal design of wireless networks, especially toward 5G evolution and 6G to support diverse use cases with stringent requirements.

As noted above, the topic of FL for radio mapping has been studied in the literature, but the previous work has many drawbacks as described above.

Accordingly, in one aspect there is provided a method for use in generating a three-dimensional, 3D, radio map. The method is performed by a first unmanned aerial vehicle, UAV. The method includes generating a locally trained model configured to map input data to a predicted signal quality value, wherein the input data comprises location information specifying a location in a 3D space, and the predicted signal quality value is one of: predicted average Reference Signal Received Power, RSRP, value; Signal-to-Noise Ratio, SNR; Signal-to-Interference-plus-Noise Ratio, SINR; Reference Signal Received Quality, RSRQ; Block Error Rate, BLER; or throughput. The method also includes transmitting model parameters for the locally trained model to a network node, wherein the network node is a base station, server, or a second UAV. In another aspect there is provided a computer program comprising instructions which when executed by processing circuitry of an UAV causes the UAV to perform the method. In another aspect there is provided an UAV that is configured to perform the method. The UAV may include memory and processing circuitry coupled to the memory.

In another embodiment, the method for use in generating the 3D radio map is performed by a network node. In such an embodiment the method includes receiving from a first UAV first local model parameters for a first local model trained by the first UAV, wherein the first local model is configured to map input data to a predicted signal quality value, wherein the input data comprises location information specifying a location in a 3D space and channel state information associated with the location in the 3D space, and the predicted signal quality value is one of: predicted average Reference Signal Received Power, RSRP, value; Signal-to-Noise Ratio, SNR; Signal-to-Interference-plus-Noise Ratio, SINR; or Reference Signal Received Quality, RSRQ. The method also includes generating a global model using the first local model parameters. In another aspect there is provided a computer program comprising instructions which when executed by processing circuitry of a network node causes the network node to perform the method. In another aspect there is provided a network node that is configured to perform the method. The network node may include memory and processing circuitry coupled to the memory.

An advantage of the embodiments disclosed herein is that they leverage ML to create a 3D radio map that can be used for efficient design, deployment, and operation of cellular networks (e.g., in 5G evolution toward 6G). The embodiments are highly efficient in terms of computational cost, deployment, and operational cost, and energy consumption. Moreover, the embodiments are beneficial in terms of privacy and security aspects.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 illustrates a system according to an embodiment.

FIG. 3 illustrates a system according to an embodiment.

FIG. 4 illustrates an information exchange according to an embodiment.

FIG. 5 illustrates using 3D radio maps for handover optimization.

FIG. 6 illustrates using 3D radio maps to control UAV mobility (e.g., altitude) adjustments.

FIG. 7 illustrates using 3D radio maps for beam optimization.

FIG. 8 illustrates using moving base stations for dynamic connectivity.

FIG. 9 is a flowchart illustrating a process according to an embodiment.

FIG. 10 is a flowchart illustrating a process according to an embodiment.

FIG. 11 is a block diagram showing some components of a UAV according to an embodiment.

FIG. 12 is a block diagram showing some components of a base station according to an embodiment.

FIG. 13 is a block diagram showing some components of a server according to an embodiment.

### DETAILED DESCRIPTION

The embodiments disclosed herein leverage ML to create a 3D radio map that can be used for, among other things, efficient design, deployment, and operation of cellular networks (e.g., in 5G evolution toward 6G). In particular use cases, the proposed embodiments leverage FL to create a 3D radio map (e.g., received signal power (RSRP) and SINR) using UAV-UEs. Such information is important for efficient design and optimization of cellular networks for providing reliable 3D connectivity.

### Overview

Embodiments disclosed herein exploit a network's distributed nature and focus mainly on the UAV-UE (or “UAV” for short) use case. UAV-to-UAV communication and UAV-to-Ground communication enables many services in 5G networks and beyond 5G networks. With the increasing number of devices and scenarios a huge amount of data is generated which can be used to perform multiple tasks (e.g., resource allocation, route planning, particular service delivery, and extending network coverage).

Conventionally, a central entity requires access to all of the local data and performs processing on the data and afterwards informs the respective local clients to perform a certain task. Providing the data to the central entity requires resources and incurs delay. Keeping in mind the distributed nature of many current and future networks and to enable coordination between network entities in a secure manner, one must look for novel solutions which can maximize the benefits (save resources and minimize delay) and can operate in a distributed setting. In this regard, FL is an important tool, that can operate in a distributed setting of network and maximize a network wide reward.

### Federated Learning (FL) for Generating a Radio Map (e.g., a 3D Radio Map)

### General Setup

Utilizing FL is motivated by the fact that multiple clients (e.g., UAVs) collaborate in solving a global problem (e.g., power saving). In one non-limiting example of a system model in our scenario, there is a set of K clients and an input dataset D (e.g., SNR, SIR, SINR, RSRP, RSRQ, and user throughput values within a desired 3D space).

The dataset can be used to enable each client to perform an output action such as resource allocation, power allocation, and maneuvering to a certain location. In one embodiment, the dataset is partitioned over the clients, i.e., D={D₁, D₂, . . . , D_{C}) wherein Dₖ is the local dataset of client k, nₖ is the size of client k's local dataset, C is the number of participating clients (i.e., C≤K), and

$$n = {\sum }_{k = 1}^{C} {n}_{k}$$

is the size of the entire dataset.

The clients are in different places and the local dataset for any particular client is completely different and independent of the local dataset of the other clients. Because the clients have independent local datasets, performing a local optimization at each client can be done. If, however, one wants to optimize the actions of all the clients globally, it is not possible because no other node has the knowledge of the local dataset of the other clients. That is, the dataset D is distributed across participating clients (i.e., D consists of sets of C local datasets) and transferring each local dataset to a centralized location incurs additional overhead in terms of latency and resources.

To avoid this overhead of transferring the local datasets to a central location and getting a decision in response, a distributed optimization algorithm can be used, which uses the data locally and performs decisions in such a way that the global objective is maximized (or minimized). Moreover, modern ML tools also offer solutions to perform distributed optimization without sharing the local datasets which is important from privacy and security perspective. In this regard, FL is a key tool, that can operate in a distributed setting of network and maximize a global reward.

In one embodiment, at the beginning of each cycle, a “central” server initializes a subset S of clients with global parameters w (e.g., weights of neural network). Alternatively, it may not be necessary that each client needs the global weights and each client can initialize its own parameters.

Each client within the set of S clients produces a prediction based on the global parameters and its local dataset, and performs an update to an initialized model. The clients then share the updated local model parameters with the central server, which computes an aggregate of the model parameters, and sends the computed model parameters back to the clients. The process repeats itself until a convergence point is reached. The loss function defines the error of prediction ‘ŷᵢ−yᵢ’, where ‘ŷᵢ’ is the optimal inactive configuration for input ‘xᵢ’, which will lead to maximum/minimum global reward. The goal here is to minimize the loss function ‘ƒ(·)’ by optimizing the parameter ‘w’. The optimization of a non-convex neural network utility can be mathematically formulated as follows:

$${min}_{w} f ( w ) = \frac{1}{n} {\sum }_{i = 1}^{n} {f}_{k} ( {w}_{k} )$$

The loss function of client ‘k’ represents

$${f}_{k} ( {w}_{k} ) = \frac{1}{{n}_{k}} {\sum }_{i = 1}^{{n}_{k}} l ( {x}_{i} , {y}_{i} ; {w}_{k} ) ,$$

the loss of prediction over client k's local dataset Dₖ. A lower value of loss function will result in small difference between the optimal and predicted configuration, and a higher value of loss function results in huge difference. The above formulation can now be re-written for a fraction (1/c) of K clients in a federated optimization scenario as:

$${min}_{w} f ( w ) = {\sum }_{k = 1}^{( 1 / c ) \times K} \frac{{n}_{k}}{n} {f}_{k} ( {w}_{k} )$$

The output of federated optimization problem is a set of optimal client decisions for participating clients, which will maximize/minimize the global reward. In here, each client has a deep neural network (DNN) which uses x fully connected layers. The input xᵢ is fed into a fully connected input layer. The result from input layer is passed on to x fully connected hidden layers and the aggregated data is passed on to the output layer. All the layers use rectified linear activation units (ReLU) activation except the output layer, which uses softmax activation. The output yᵢ of the DNN is a soft decision which indicates the probability of performing certain action for a client.

Here, C is the number of participating clients. A participating client is a client that plays a part in the FL process. K is the total number of clients in the system, all of which can receive the global parameters, no matter they use those parameters or not. Now C is a subset/fraction of K (i.e., C=(1/c)×K), and this subset can be chosen based on its desire to participate, based on the client activity, or based on some other triggering mechanism. The selection of clients can be performed on various criteria and the change in client selection does not change the name from Federated learning to some other learning.

Because clients have different collected data (i.e., different local datasets), different participating clients may result in different training loss. Meanwhile, client selection also depends on wireless environmental conditions such as channel conditions, client location, client transmit power. This is because the clients with different channel conditions may need different number of time slots to transmit FL parameters. To select the subset of participating clients, it needs to be first analyzed how wireless parameters such as client movement, wireless channel conditions affect the FL convergence. Here, optimization and gradient descent methods can be used to analyze the FL convergence. Then, the subset of participating clients can be selected for FL training.

The above framework involves data collection for developing a machine learning model, building and training the model, deploying the model, and updating the model. The data collection can be performed online (learning while on the job) or offline (learning without the job).

### UAV System

FL can be implemented at different network agents such as base station (e.g., gNBs) and UAVs.

### (A) First Use Case

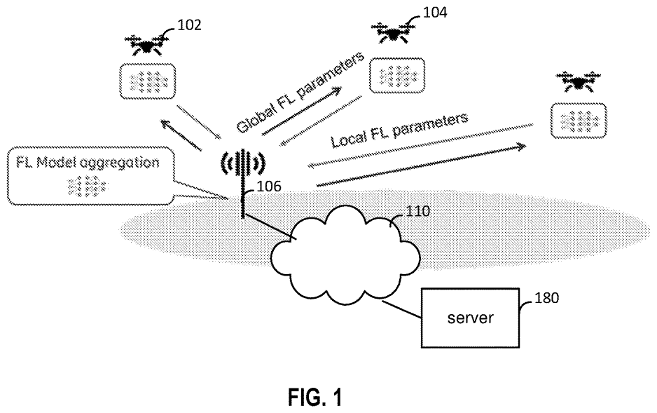

In this use case, illustrated in FIG. 1, 3D Radio Mapping is performed using one base station (BS) 106 and Multiple UAVs (e.g., UAV 102 and UAV 104). The procedure of using FL, only one BS, and multiple UAVs for 3D radio mapping is given as follows:

(1) BS 106 (or server 180) acts as a central unit to aggregate the local FL model parameters transmitted by multiple UAVs. That is, each participating UAV provides its local FL model parameters to the BS or the server. Meanwhile, the BS or the server will determine the subset of UAVs that will participate in FL training at each training iteration. In some embodiments, the BS/server determines the subset of UAVs by selecting i) UAVs that are serving at least a threshold number (T) of users, ii) UAVs that meet one or more performance criterions (e.g., a battery level criterion), and/or iii) UAVs located in any one of one or more specific areas.

(2) When a UAV moves to a new location, it needs to collect wireless signal data. In particular, x and y are used to represent one training data sample, where x is the input vector and y is an output vector. In one embodiment, x includes the 3D location of the UAV; in another embodiment x includes the 3D location and channel state information (i.e., information indicating channel properties of a communication link). In one embodiment, y is the average RSRP received by the UAV. Therefore, one UAV needs to collect at least one training data sample per location.

(3) Given the collected training data samples, each UAV trains its local FL model. The equation of each UAV updating its local FL model is expressed as:

$${w}_{k}^{t} = {w}_{k}^{t - 1} + γ {\sum }_{i ∈ \tilde{S}} ∇ f ( w , {x}_{i} , {y}_{i} ) ,$$

where \tilde{S} is a subset of data training samples used to update the local FL model, t is the index of the local model update, and γ is a learning rate.

(4) After training the FL model, the selected UAVs will transmit their local FL model parameters to the BS/server. That is, the UAVs can transmit a gradient vector of the FL model (i.e., difference between current parameters and previous parameters) or the FL model parameters.

(5) The BS/server uses the received local FL parameters to generate a global FL model, as shown in

$$w = {\sum }_{k = 1}^{\dot{K}} \frac{{n}_{k} {w}_{k}}{n} .$$

Then, the BS/server transmits the global FL model w back to all users.

Repeat from (2) to (5) until convergence is achieved.

### (B) Second Use Case

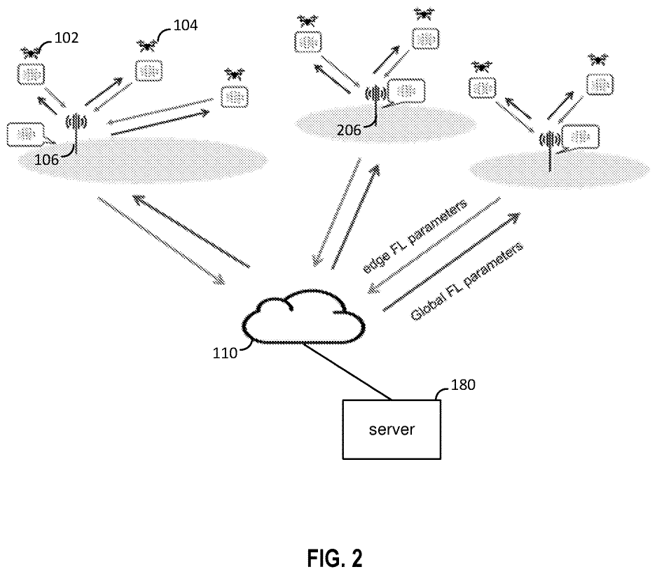

For a network that consists of multiple UAVs and multiple BSs, as shown in FIG. 2, FL will be jointly implemented by BSs and UAVs. The specific training process is as follows:

(1) As done in steps 1-4 in case A, each UAV first collects data and trains its local FL model and transmits its local FL parameters to one BS/server.

(2) Each BS/server k uses the received local FL parameters to generate an edge FL model

$${w}_{e}^{k}$$

and sends the edge FL parameters to other BSs/servers.

(3) Each BS/server uses the received edge FL parameters to generate a global FL model, which is shown as

$${w}_{g} = {\sum }_{k = 1}^{B} \frac{{n}_{e}^{k} {w}_{e}^{k}}{n} ,$$

where B is the number of BSs/servers and w_{g} is the global FL model.

(4) Each BS/server transmits w_{g} to its associated UAVs.

(5) Repeat from (1) to (4) until convergence is achieved.

### (C) Third Use Case

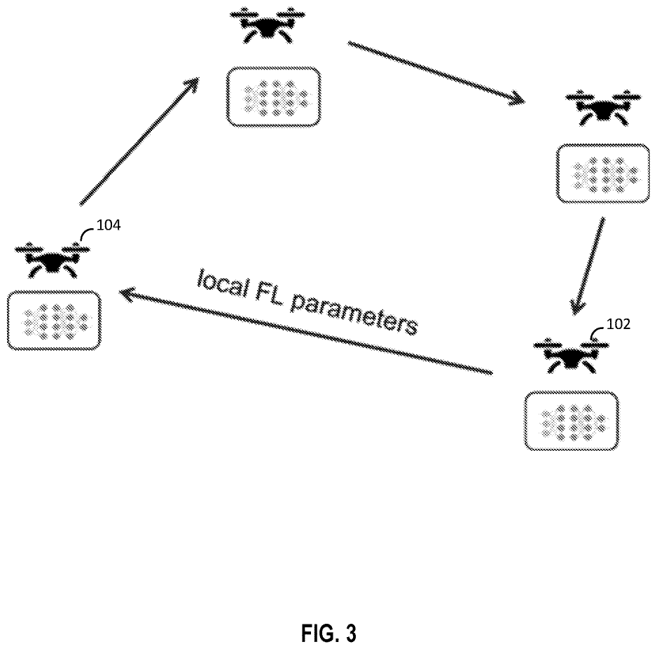

FL can also be implemented by a network that consists of only UAVs without the reliance of BSs, as shown in FIG. 3. The training process is given as follows:

(1) Each UAV needs to determine the other UAVs to which the UAV will transmit FL parameters (i.e., each UAV determines the other UAVs to which the UAV is “connected”). Here, the UAV connection depends on all UAVs' locations and needs to guarantee the convergence of FL. Graph theory is used to determine the UAV connection.

(2) Each UAV collects data, trains its FL model, and transmits its FL parameters to each other UAV to which the UAV is “connected” (i.e., the UAV's connected UAVs).

(3) Each UAV will use the received FL parameters to update its FL model.

(4) Repeat from (1) to (3) until convergence is achieved.

### Data Collection for Developing the Machine Learning Model

To build the machine learning model, data must first be collected. The types of data may include RSRP, RSRQ, SNR, SIR, SINR, and user throughput values within a desired 3D space. Moreover, the data collection can be done for various parameters such as BS locations, BS antennas patterns, number of BSs, and UAV altitude (or 3D location).

The data can be obtained by one or more of the following methods or a combination of these methods:
(1) Link- and/or system-level computer simulations of the air-to-ground (A2G) network;
(2) Actual data obtained from an A2G network and using a number of UAVs for data collection.

Existing data can also be utilized. New data can be collected to be integrated with existing data to enhance the quality and accuracy of the data.

In one embodiment, the BS configures one or more UAVs to measure and report RSRP/RSRQ/SNR/SIR/SINR and the 3D location of UAVs.

In another embodiment, the BS configures one or more UAVs to measure and report SNR/SIR/SINR/RSRP/RSRQ/throughput, and the BS estimates the UAV's 3D location corresponding to the reported measurements.

In another embodiment, the network deploys one or more UAVs dedicated to data collection. These UAVs measure SNR/SIR/SINR/RSRP/RSRQ, and their 3D locations periodically. The UAVs may store the data locally which is fetched after the mission. Alternatively, the UAVs transmit the data to the network during the mission.

### Model Adaptation and Signaling Aspects

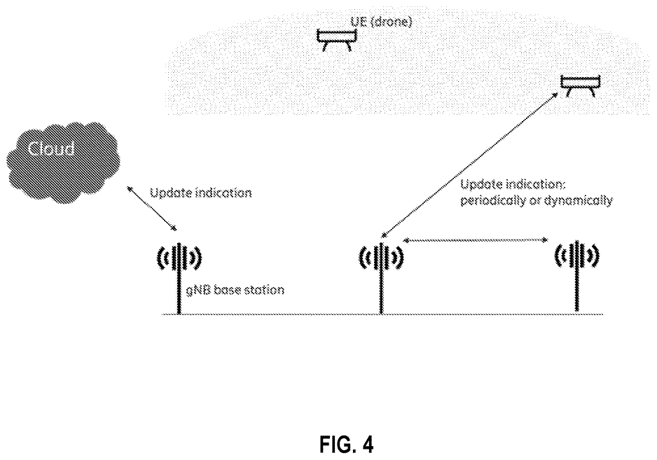

Once a model is built, the next step is to deploy and use the model in networks. Also, the model needs to be updated as needed. While the model is deployed and used in the network, the model can be updated by adapting to any changes in the environment/scenario and incorporating new data. The model update can be performed periodically or in an event-triggered manner (see, e.g., FIG. 4). For example, a 3D radio map can change due to: (1) Change of environment (e.g., blockage) which impacts the propagation channel; and (2) Changes in the receiver and/or transmitter parameters. For example, any variation in the transmit power, antenna orientation, transmission schemes, and scheduling mechanisms affects the 3D radio map.

To have efficient network design based on 3D radio maps, it is important to update the model and signaling solutions for information exchange between different components of the network (e.g., UAV, BS, cloud).

In one embodiment, the update is done periodically with a pre-defined periodicity. The periodicity can be pre-configured for network components or indicated to them via dedicated signaling. For example, a BS can inform UAVs using radio resource control (RRC) signaling. In addition, a time offset can be introduced to accommodate for design adaptation and proper scheduling decisions. Meanwhile, a default behavior can be defined and signaled to the components during adaptations.

In another embodiment, the update is done dynamically and in an event-triggered manner. Such indication can be generated by a network component that either causes or observes the changes. For example, if a BS changes its transmit power, it can inform other BSs about this change. Accordingly, the model can be updated as needed. Moreover, a BS can signal such dynamic updates to UEs using the DCI (downlink control information) signaling.

### Using 3D Radio Maps for Network Design and Optimization

The generated 3D radio map can be used for the following design and network optimization problems.

### (1) UAV Mobility Support and Handover Management

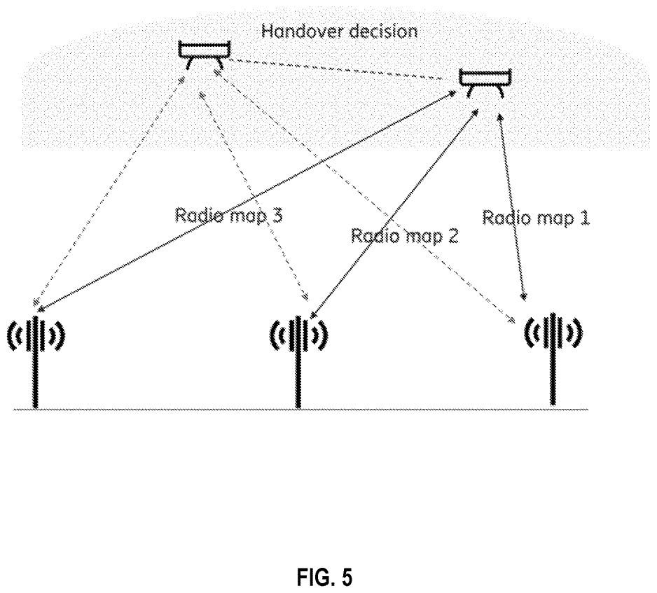

A 3D radio map can be used for handover management and UAV mobility support. For example, as illustrated in FIG. 5, each UAV can connect to a set of base stations such that it has sufficient connectivity with minimum number of handovers along its route. From UAV perspective, the 3D radio map can be different depending on the serving base station and cell association (i.e., base station associated to the UAV). In this case, a set of 3D radio maps can be provided for each UAV based on different possible UAV-to-base station associations. These 3D radio maps are then used for handover optimization.

### (2) UAV 3D Deployment and Trajectory Optimization (Including Adjusting Altitude)

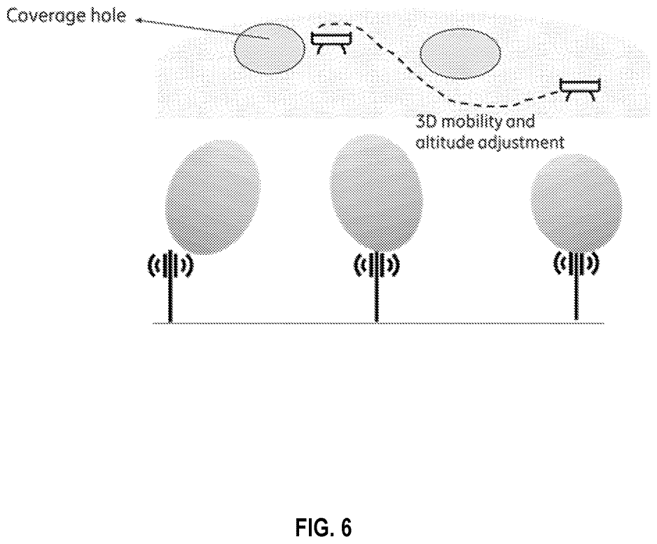

A 3D radio map can show a number of coverage holes (space without coverage). As illustrated in FIG. 6, The 3D location and trajectory of each UAV can be optimized such that the coverage holes are avoided.

### (3) Antenna Pattern, Beamwidth, and Beam Direction Optimization

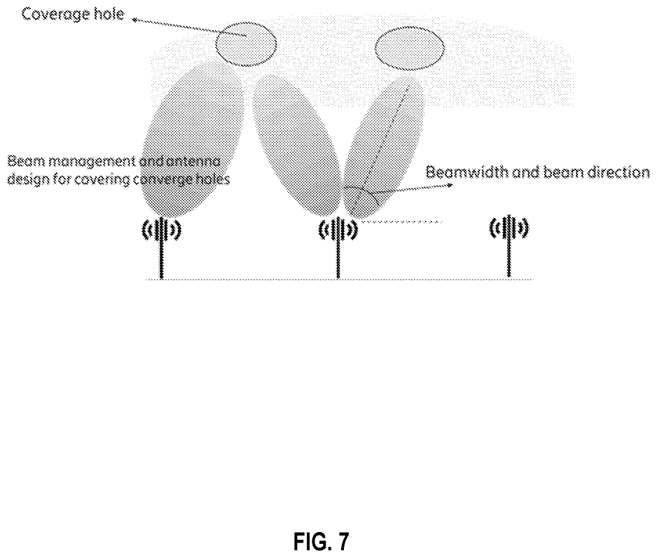

As illustrated in FIG. 7, given a 3D radio map, the antenna pattern, beamwidth, beam direction, and number of beams for ground base stations can be optimized to minimize the coverage holes.

### (4) Network Planning Including Base Station Deployment and Exploiting Mobile Base Stations for Dynamic Connectivity.

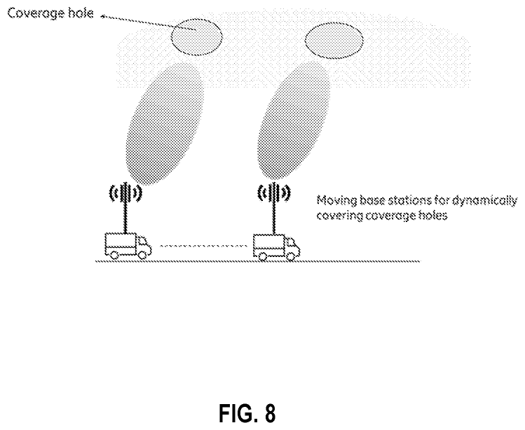

Network planning and further optimization can also be done based on the 3D radio map. For instance, one can use mobile base stations (e.g., cell on truck) to dynamically change the 3D radio map as desired. For example, as illustrated in FIG. 8, a mobile base station can move to cover coverage holes when needed.

### (5) Power Control for Interference Management Based on the Available 3D Radio Maps

Power control and interference management mechanisms can be done for base stations considering the 3D radio map. In this case, the 3D radio map changes based on the scenario. Moreover, various information such as UAVs' mobility patterns can be used for power control and interference management.

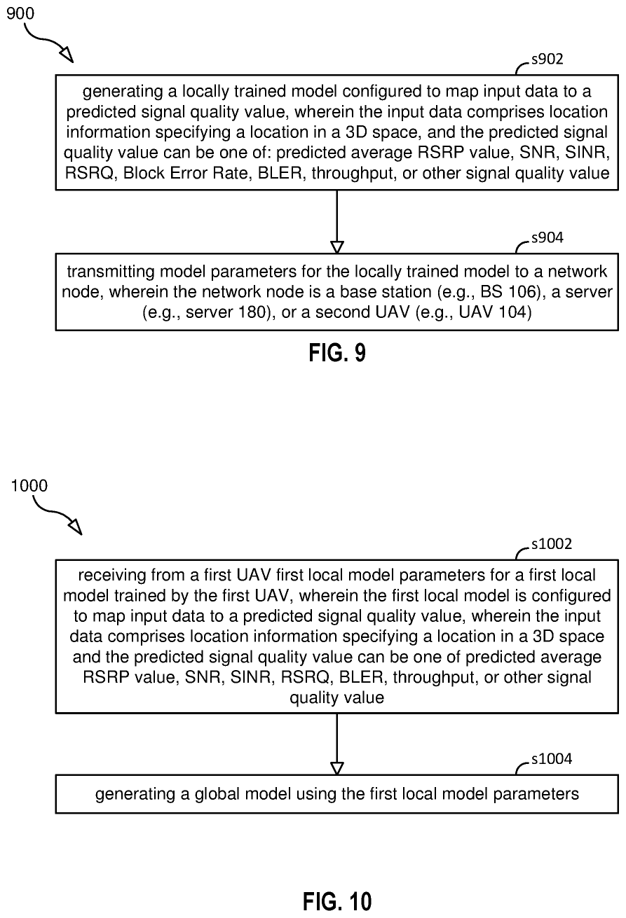

FIG. 9 is a flow chart illustrating a process 900, according to an embodiment, for use in generating a 3D radio map. Process 900 may be performed by a first UAV (e.g., UAV 102) and begin in step s902.

Step s902 comprises generating a locally trained model configured to map input data to a predicted signal quality value, wherein the input data comprises location information specifying a location in a 3D space, and the predicted signal quality value is one of: predicted average RSRP value, SNR, SINR, RSRQ, Block Error Rate, BLER, or throughput.

Step s904 comprises transmitting model parameters for the locally trained model to a network node, wherein the network node is a base station (e.g., BS 106), a server (e.g., server 180), or a second UAV (e.g., UAV 104).

In some embodiments, the locally trained model is a trained artificial neural network. In some embodiments, generating the locally trained model comprises generating the locally trained model using a local training process that comprises: obtaining a set of training examples; and training the model using the set of training examples, wherein a first training example within the set of training examples comprises: i) first input data, wherein the first input data comprises first location information specifying a first location in the 3D space; and ii) first output data paired with the first input data, wherein the first output data comprises a first signal quality value associated with the first location.

In some embodiments, the first input data further comprises first channel state information associated with the first location.

In some embodiments, obtaining the first output data comprises: while at the first location in the 3D space, measuring a plurality of reference signals transmitted by transmission and reception point, TRP, to obtain a plurality of reference signal, RS, quality values (e.g., a plurality of RSRP values and/or RSRQ values) and calculating the average of the plurality of RS quality values, wherein the first signal quality value is the calculated average RS quality value.

In some embodiments, the method comprises transmitting the model parameters to the base station. In some embodiments the process also includes, after transmitting the model parameters for the locally trained model to the base station, receiving from the base station model parameters for a globally trained model.

In some embodiments, the method comprises transmitting the model parameters to the second UAV.

In some embodiments, the process includes determining a set of other UAVs, wherein the set of other UAVs includes the second UAV, and transmitting the model parameters for the locally trained model to each other UAV included in the set of other UAVs.

In some embodiments the process also includes receiving the 3D radio map; and using the 3D radio map for handover management. In some embodiments the process also includes using the 3D radio map for trajectory adjustments.

FIG. 10 is a flow chart illustrating a process 1000, according to an embodiment, for use in generating a 3D radio map. Process 1000 may be performed by a network node (e.g., BS 106, server 180) and begin in step s1002.

Step s1002 comprises receiving from a first UAV (e.g., UAV 102) first local model parameters for a first local model trained by the first UAV, wherein the first local model is configured to map input data to a predicted signal quality value, wherein the input data comprises location information specifying a location in a 3D space and channel state information associated with the location in the 3D space, and the predicted signal quality value can be one of predicted average RSRP value, SNR, SINR, RSRQ, throughput, or other signal quality value.

Step s1004 comprises generating a global model using the first local model parameters.

In some embodiments, the network node is a first BS (e.g., BS 106) and the process further comprises, prior to generating the global model, generating a first edge model and transmitting to a second BS (e.g., BS 206) first edge model parameters for the first edge model. In some embodiments the process also includes receiving from the second BS second edge model parameters for a second edge model generated by the second BS, wherein the first BS generates the global model using the second edge model parameters and the first local model parameters.

In some embodiments the process also includes transmitting to the first UAV first global model parameters for the generated global model.

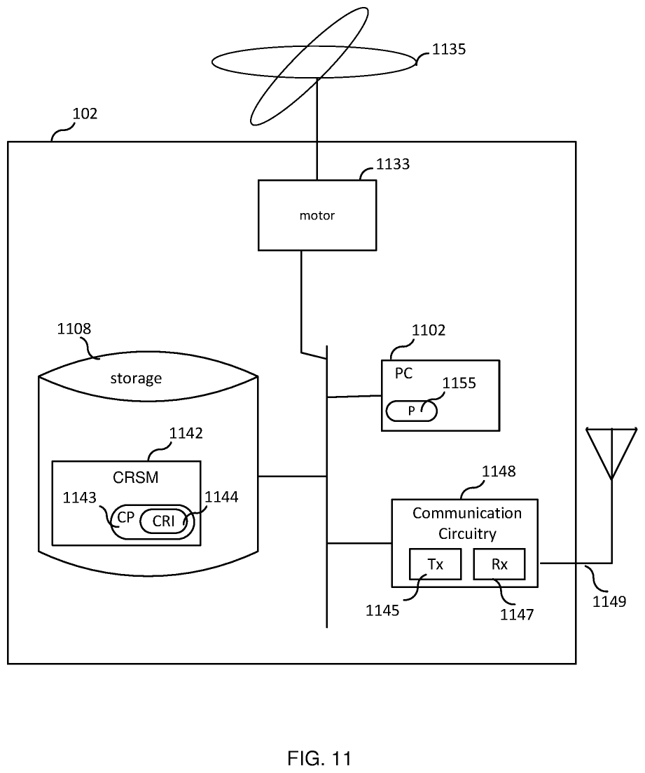

FIG. 11 is a block diagram of UAV 102, according to some embodiments. As shown in FIG. 11, UAV 102 may comprise: processing circuitry (PC) 1102, which may include one or more processors (P) 1155 (e.g., one or more general purpose microprocessors and/or one or more other processors, such as an application specific integrated circuit (ASIC), field-programmable gate arrays (FPGAs), and the like); communication circuitry 1148, which is coupled to an antenna arrangement 1149 comprising one or more antennas and which comprises a transmitter (Tx) 1145 and a receiver (Rx) 1147 for enabling UAV 102 to transmit data and receive data (e.g., wirelessly transmit/receive data); a storage unit (a.k.a., “data storage system”) 1108, which may include one or more non-volatile storage devices and/or one or more volatile storage devices; and a motor 1133 for driving a propeller 1135. In embodiments where PC 1102 includes a programmable processor, a computer readable storage medium (CRSM) 1142 may be provided. CRSM 1142 may store a computer program (CP) 1143 comprising computer readable instructions (CRI) 1144. CRSM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes UAV 102 to perform steps described herein (e.g., steps described herein with reference to the flow charts). In other embodiments, UAV 102 may be configured to perform steps described herein without the need for code. That is, for example, PC 1102 may consist merely of one or more ASICs. Hence, the features of the embodiments described herein may be implemented in hardware and/or software.

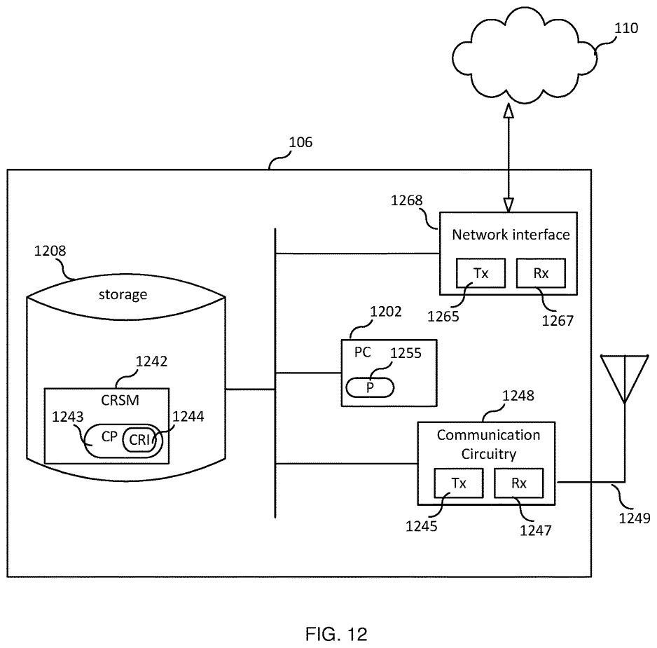

FIG. 12 is a block diagram of base station 106, according to some embodiments for performing the base station methods disclosed herein. As shown in FIG. 12, base station 106 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., base station may be a distributed computing apparatus); a network interface 1268 comprising a transmitter (Tx) 1265 and a receiver (Rx) 1267 for enabling base station 106 to transmit data to and receive data from other nodes connected to a network 110 (e.g., an Internet Protocol (IP) network) to which network interface 1268 is connected; communication circuitry 1248 (e.g., radio transceiver circuitry comprising an Rx 1247 and a Tx 1245) coupled to an antenna system 1249 for wireless communication with UEs or other nodes; and a storage unit (a.k.a., “data storage system”) 1208, which may include one or more non-volatile storage devices and/or one or more volatile storage devices. In embodiments where PC 1202 includes a programmable processor, a computer readable storage medium (CRSM) 1242 may be provided. CRSM 1242 may store a computer program (CP) 1243 comprising computer readable instructions (CRI) 1244. CRSM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes base station 106 to perform steps described herein (e.g., steps described herein with reference to one or more flow charts). In other embodiments, base station 106 may be configured to perform steps described herein without the need for code. That is, for example, PC 1202 may consist merely of one or more ASICs. Hence, the features of the embodiments described herein may be implemented in hardware and/or software.

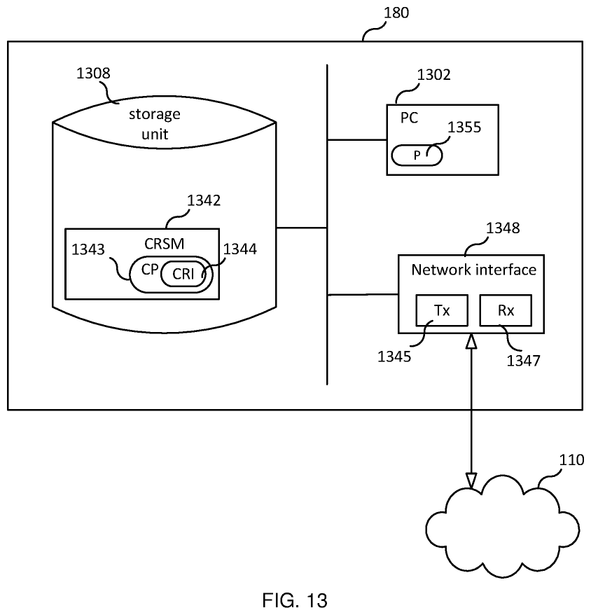

FIG. 13 is a block diagram of server 180, according to some embodiments. As shown in FIG. 13, server 180 may comprise: processing circuitry (PC) 1302, which may include one or more processors (P) 1355 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., server 180 may be a distributed computing apparatus); at least one network interface 1348 (e.g., a physical interface or air interface) comprising a transmitter (Tx) 1345 and a receiver (Rx) 1347 for enabling server 180 to transmit data to and receive data from other nodes connected to a network 110 (e.g., an Internet Protocol (IP) network) to which network interface 1348 is connected (physically or wirelessly) (e.g., network interface 1348 may be coupled to an antenna arrangement comprising one or more antennas for enabling server 180 to wirelessly transmit/receive data); and a storage unit (a.k.a., “data storage system”) 1308, which may include one or more non-volatile storage devices and/or one or more volatile storage devices. In embodiments where PC 1302 includes a programmable processor, a computer readable storage medium (CRSM) 1342 may be provided. CRSM 1342 may store a computer program (CP) 1343 comprising computer readable instructions (CRI) 1344. CRSM 1342 may be a non-transitory computer readable medium, such as, magnetic media (e.g., a hard disk), optical media, memory devices (e.g., random access memory, flash memory), and the like. In some embodiments, the CRI 1344 of computer program 1343 is configured such that when executed by PC 1302, the CRI causes server 180 to perform steps described herein (e.g., steps described herein with reference to the flow charts). In other embodiments, server 180 may be configured to perform steps described herein without the need for code. That is, for example, PC 1302 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] RP-213599, “Study on Artificial Intelligence (AI)/Machine Learning (ML) for NR Air Interface,” 3GPP Release 18, December 2021.
[2] Khamidehi, Behzad, and Elvino S. Sousa. “Federated learning for cellular-connected UAVs: Radio mapping and path planning.” In IEEE Global Communications Conference, 2020: https://arxiv.org/pdf/2008.10054.pdf.
[3] S. Zhang and R. Zhang, “Radio Map Based Path Planning for Cellular-Connected UAV,” in IEEE Global Communications Conference (GLOBECOM), 2019.
[4] Zhang, Shuowen, and Rui Zhang. “Radio map-based 3D path planning for cellular-connected UAV.” IEEE Transactions on Wireless Communications 20.3 (2020): 1975-1989.

### ABBREVIATIONS

3D Three-Dimensional
3GPP 3rd Generation Partnership Project
5G Fifth-generation mobile system
AI Artificial Intelligence
BLER Block Error Rate
BS Base Station
BW Bandwidth
BWP Bandwidth Part
DCI Downlink Control Information
FL Federated Learning
HO Handover
LOS Line of Sight
MI Machine Learning
mMTC Massive Machine Type Communications
MTC Machine-type Communications
NN Neural Network
NR New Radio
PRB Physical Resource Block
RE Resource Element
REG Resource Element Group
RF Radio Frequency
RSRP Reference Signal Received Power
RSRQ Reference Signal Received Quality
SINR Signal-to-Interference-plus-Noise Ratio
SCS Subcarrier Spacing
SIR Signal-to-Interference Ratio
SNR Signal-to-Noise Ratio
SSB Synchronization Signal Block
UAV Unmanned Aerial Vehicles
UE User equipment

1. A method for use in generating a three-dimensional (3D) radio map, the method being performed by a first unmanned aerial vehicle (UAV) and comprising:
generating a locally trained model configured to map input data to a predicted signal quality value, wherein the input data comprises location information specifying a location in a 3D space, and the predicted signal quality value is a predicted average reference signal received power (RSRP) value, a predicted signal-to-noise ratio, a predicted signal-to-interference-plus-noise ratio, a predicted reference signal received quality (RSRQ) value, a predicted block error rate, or a predicted throughput value; and
transmitting model parameters for the locally trained model to a network node, wherein the network node is a base station, server, or a second UAV.

2. The method of claim 1, wherein generating the locally trained model comprises generating the locally trained model using a local training process, the local training process comprising:
obtaining a set of training examples; and
training the model using the set of training examples, wherein
a first training example within the set of training examples comprises:
i) first input data, wherein the first input data comprises first location information specifying a first location in the 3D space; and
ii) first output data paired with the first input data, wherein the first output data comprises a first signal quality value associated with the first location.

3. The method of claim 2, wherein the first input data further comprises first channel state information associated with the first location.

4. The method of claim 2, wherein obtaining the first output data comprises:
while at the first location in the 3D space, measuring a plurality of reference signals transmitted by transmission and reception point (TRP) to obtain a plurality of reference signal, RS, quality values and calculating the average of the plurality of RS quality values, wherein the first signal quality value is the calculated average RS quality value.

5. The method of claim 1, wherein the method comprises transmitting the model parameters to the base station.

6. The method of claim 5, wherein the method further comprises, after transmitting the model parameters for the locally trained model to the base station, receiving from the base station model parameters for a globally trained model.

7. The method of claim 1, wherein the method comprises transmitting the model parameters to the second UAV.

8. The method of claim 1, wherein the method further comprises:
determining a set of other UAVs, wherein the set of other UAVs includes the second UAV, and
transmitting the model parameters for the locally trained model to each other UAV included in the set of other UAVs.

9. The method of claim 1, wherein the method further comprises:
receiving the 3D radio map; and
using the 3D radio map for handover management.

10. The method of claim 1 wherein the method further comprises:
receiving the 3D radio map; and
using the 3D radio map for trajectory adjustments.

11. The method of claim 10, wherein the locally trained model is a trained artificial neural network.

12. A method for use in generating a three-dimensional (3D) radio map, the method being performed by a network node and comprising:
receiving from a first unmanned aerial vehicle (UAV), first local model parameters for a first local model trained by the first UAV, wherein the first local model is configured to map input data to a predicted signal quality value, wherein the input data comprises location information specifying a location in a 3D space, and the predicted signal quality value is a predicted average reference signal received power (RSRP) value, a predicted signal-to-noise ratio, a predicted signal-to-interference-plus-noise ratio, a predicted reference signal received quality (RSRQ) value, a predicted block error rate, or a predicted throughput value; and
generating a global model using the first local model parameters, wherein
the network node is a base station, server, or a second UAV.

13. The method of claim 12, wherein
the network node is a first base station (BS), and
the method further comprises, prior to generating the global model, generating a first model and transmitting to a second BS first model parameters for the first model.

14. The method of claim 13, wherein
the method further comprises receiving from the second BS second model parameters for a second model generated by the second BS, and
the first BS generates the global model using the second model parameters and the first local model parameters.

15. The method of claim 12, wherein the method further comprises:
transmitting to the first UAV first global model parameters for the generated global model.

16. A non-transitory computer readable storage medium storing a computer program comprising instructions which when executed by processing circuitry of an unmanned aerial vehicle (UAV) causes the UAV to perform the method of claim 1.

17. A non-transitory computer readable storage medium storing a computer program comprising instructions which when executed by processing circuitry of a network node causes the network node to perform the method of claim 12.

18. A first unmanned aerial vehicle (UAV) for use in generating a three-dimensional (3D) radio map, the first UAV being configured to perform a method that comprises:
generating a locally trained model configured to map input data to a predicted signal quality value, wherein the input data comprises location information specifying a location in a 3D space, and the predicted signal quality value is a predicted average reference signal received power (RSRP) value, a predicted signal-to-noise ratio, a predicted signal-to-interference-plus-noise ratio, a predicted reference signal received quality (RSRQ) value, a predicted block error rate, or a predicted throughput value; and
transmitting model parameters for the locally trained model to a network node, wherein the network node is a base station, server, or a second UAV.

19. The first UAV of claim 18, wherein generating the locally trained model comprises generating the locally trained model using a local training process, the local training process comprising:
obtaining a set of training examples; and
training the model using the set of training examples, wherein
a first training example within the set of training examples comprises:
i) first input data, wherein the first input data comprises first location information specifying a first location in the 3D space; and
ii) first output data paired with the first input data, wherein the first output data comprises a first signal quality value associated with the first location.

20. A network node for use in generating a three-dimensional (3D) radio map, the network node being configured to perform a method that includes:
receiving from a first unmanned aerial vehicle, UAV, first local model parameters for a first local model trained by the first UAV, wherein the first local model is configured to map input data to a predicted signal quality value, wherein the input data comprises location information specifying a location in a 3D space, and the predicted signal quality value is a predicted average reference signal received power (RSRP) value, a predicted signal-to-noise ratio, a predicted signal-to-interference-plus-noise ratio, a predicted reference signal received quality (RSRQ) value, a predicted block error rate, or a predicted throughput value; and
generating a global model using the first local model parameters, wherein
the network node is a base station, server, or a second UAV.

21. (canceled)
